(19) United States
(12) Patent Application Publication
(10) Pub. No.: US 2008/0234459 A1
(43) Pub. Date: Sep. 25, 2008

(54) Process for Preparing Polyoxymethtylene Homopolymers or Copolymers

(75) Inventors: Neven Lang, Mannheim (DE); Knut Zollner, Mannheim (DE); Achim Stammer, Freinsheim (DE); Elmar Stockelmann, Mannheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF SE, Ludwigshafen (DE)

(21) Appl. No.: 12/064,893

(22) PCT Filed: Aug. 25, 2006
(86) PCT No.: PCT/EP2006/065693

§ 371 Date: Feb. 26, 2008

(30) Foreign Application Priority Data
Aug. 26, 2005 (DE) 10 2005 040 500.2

(51) Int. Cl. C08G 65/08

(52) U.S. Cl. 528/249

(57) ABSTRACT

A process for preparing polyoxymethylene homopolymers or copolymers by homopolymerization or copolymerization of trioxane or additionally of suitable comonomers, in which
trioxane which still comprises residual monomers is firstly prepared in a monomer plant and is
degassed in one or more stages to give one or more vapor streams (13, 14) which are, if appropriate, fed to a condenser (K) in which the condensable fractions of these vapor streams are condensed to give a condensate (15) which is recycled to the polymerization reactor (P) and one or more gaseous, formaldehyde-comprising streams (16) and also a partially degassed polyoxymethylene homopolymer or copolymer (17) which
is fed to an extruder (E) or kneader and is mixed with customary additives and processing aids in this
to give a polymer melt (19) and
extraction of a formaldehyde-comprising extruder or kneader offgas (18) from the extruder (E) or kneader,
wherein the formaldehyde-comprising secondary streams (14, 16, 18) from the polymer plant are recycled directly without addition of auxiliaries to the monomer plant, is proposed

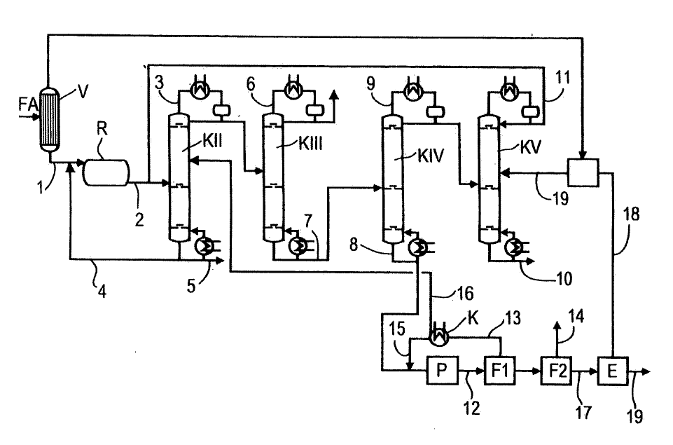

The invention relates to a process for preparing polyoxymethylene homopolymers or copolymers, in which trioxane is firstly prepared and purified in a monomer plant and subsequently polymerized, if appropriate, with addition of suitable comonomers, in a polymerization plant. Polyoxymethylene polymers (POMs, also referred to as polyacetals) are obtained by homopolymerization or copolymerization of 1,3,5-trioxane (trioxane for short), formaldehyde or another formaldehyde source. The conversion is usually not complete; rather, the crude POM polymer still comprises up to 40% of unreacted monomers. Such residual monomers are, for example, trioxane and formaldehyde and also comonomers such as 1,3-dioxolane, 1,3-butanediol formal or ethylene oxide which are optionally used. For the present purposes, the term POM encompasses both homopolymers and copolymers.

The residual monomers have to be removed from the crude polymers by means of a work-up, for example by degassing.

Since, as mentioned above, complete conversion can generally not be attained and the proportion of residual monomers in the crude POM polymer is correspondingly high at up to 40%, the residual monomers to be separated off have to be utilized, generally by recycling, preferably to the polymer process or to the process for preparing the monomers.

Thus, for example, DE 102005002413.0 discloses firstly preparing suitable monomers in a monomer plant and subsequently transferring these to a polymerization reactor and polymerizing them there. After the preparation of POM, unreacted residual monomers are removed by degassing by bringing the polymer to a temperature of from 165 to 270° C. at a pressure of from 10 to 100 bar. This results in formation of a melt which is degassed at a pressure of from 1.05 to 9 bar and a temperature of from 160 to 240° C. in at least one degassing apparatus. According to the process of DE 102005002413.0, the residual monomers removed by the degassing process can be reused as starting materials in POM production, i.e. be recycled to the POM process. For example, the residual monomers can be recirculated directly to the polymerization reactor or into the feed stream to this, or be recirculated to the monomer plant.

Recirculation to the monomer plant has hitherto required the formaldehyde-comprising residual monomer streams to be scrubbed out by means of a high proportion of water in a scrubbing column. The high proportion of water required at the outlet of this scrubbing column was because precipitation of solids due to high formaldehyde/trioxane concentrations had to be avoided.

Polymerization inhibitors, for example water, alcohols, ammonia or amines, are also frequently used in known processes for suppressing the spontaneous polymerization of trioxane.

It was accordingly an object of the invention to provide a process which allows efficient reuse of the secondary streams formed in the polymer process and ensures an excellent POM product quality.

This object is achieved by a process for preparing polyoxymethylene homopolymers or copolymers by homopolymerization or copolymerization of trioxane or additionally of suitable comonomers, in which
trioxane is firstly prepared in a monomer plant by
   acid-catalyzed reaction of a high-concentration aqueous formaldehyde solution in a reactor to give a trioxane/formaldehyde/water mixture,
   distillation of the trioxane/formaldehyde/water mixture to give crude trioxane as overhead stream and
   work-up of the crude trioxane by distillation or crystallization in one or more further process steps to give trioxane and water,
the trioxane obtained in the monomer plant or additionally suitable comonomers are fed to a polymerization plant in which
   the crude polyoxymethylene homopolymer or copolymer which still comprises residual monomers is prepared in a polymerization reactor and is
   degassed in one or more stages to give one or more vapor streams which are, if appropriate, fed to a condenser to give a condensate which is recycled to the polymerization reactor and one or more gaseous, formaldehyde-comprising streams and also a partially degassed polyoxymethylene homopolymer or copolymer which
   is fed to an extruder or kneader and is mixed with customary additives and processing aids in this
   to give a polymer melt and
   extraction of a formaldehyde-comprising extruder or kneader offgas from the extruder or kneader,
   wherein the formaldehyde-comprising secondary streams from the polymer plant are recycled directly without addition of auxiliaries to the monomer plant.

Polyoxymethylene homopolymers or copolymers (POMs) are known per se and are commercially available. The homopolymers are prepared by polymerization of formaldehyde or, preferably, trioxane; in the preparation of copolymers, comonomers are additionally used.

Such POM polymers quite generally have at least 50 mol % of recurring —CH₂O— units in the main polymer chain. Polyoxymethylene copolymers are preferred, in particular those which comprise recurring —CH₂O— units together with up to 50 mol %, preferably from 0.01 to 20 mol %, in particular from 0.1 to 10 mol % and very particularly preferably from 0.5 to 6 mol %, of recurring

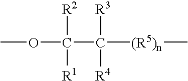

units, where R¹ to R⁴ are each, independently of one another, a hydrogen atom, a C₁-C₄-alkyl group or a halogen-substituted alkyl group having from 1 to 4 carbon atoms and R⁵ is a CH₂— group, a —CH₂O— group, a C₁-C₄-alkyl- or C₁-C₄-haloalkyl-substituted methylene group or a corresponding oxymethylene group and n is in the range from 0 to 3. These groups can advantageously be introduced into the copolymers by ring opening of cyclic ethers. Preferred cyclic ethers are those of the formula

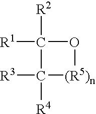

where R¹ to R⁵ and n are as defined above. Mention may be made, merely by way of example, of ethylene oxide, 1,2-propylene oxide, 1,2-butylene oxide, 1,3-butylene oxide, 1,3-dioxane, 1,3-dioxolane and 1,3-dioxepane (=butanediol formal, BUFO) as cyclic ethers and linear oligoformals or polyformals such as polydioxolane or polydioxepane as comonomers.

Likewise suitable are polyoxymethylene terpolymers which are prepared, for example, by reacting trioxane, one of the above-described cyclic ethers and a third monomer, preferably a bifunctional compound of the formula

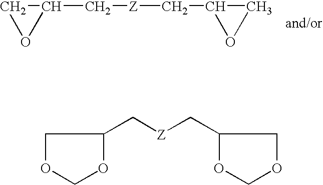

where Z is a chemical bond, —O—, —ORO— (R═C₁-C₈-alkylene or C₃-C₈-cycloalkylene).

Preferred monomers of this type are ethylene diglycide, diglycidyl ether and diethers derived from glycidyls and formaldehyde, dioxane or trioxane in a molar ratio of 2:1 and diethers derived from 2 mol of glycidyl compound and 1 mol of an aliphatic diol having from 2 to 8 carbon atoms, for example the diglycidyl ethers of ethylene glycol, 1,4-butanediol, 1,3-butanediol, cyclobutane-1,3-diol, 1,2-propanediol and cyclohexane-1,4-diol, to name only a few examples.

End-group-stabilized polyoxymethylene polymers which have predominantly C—C or —O—CH₃ bonds at the ends of the chain are particularly preferred.

The preferred polyoxymethylene copolymers have melting points of at least 150° C. and molecular weights (weight average) M_{w} in the range from 5000 to 300 000 g/mol, preferably from 7000 to 250 000 g/mol. Particular preference is given to POM copolymers having a polydispersity (M_{w}/Mₙ) of from 2 to 15, preferably from 2.5 to 12, particularly preferably from 3 to 9. The measurements are generally carried out by gel permeation chromatography (GPC)-SEC (size exclusion chromatography); the Mₙ value (number average molecular weight) is generally determined by means of GPC-SEC.

The molecular weights of the polymer can, if appropriate, be set to the desired values by means of the regulators customary in trioxane polymerization and by means of the reaction temperature and residence time. Possible regulators are acetals or formals of monohydric alcohols, the alcohols themselves and also the small amounts of water which function as chain transfer agents and whose presence can generally never be completely avoided. The regulators are used in amounts of from 10 to 10 000 ppm, preferably from 20 to 5000 ppm.

As initiators (also referred to as catalysts), use is made of the cationic initiators customary in trioxane polymerization. Suitable initiators include protic acids such as fluorinated or chlorinated alkylsulfonic and arylsulfonic acids, e.g. perchloric acid, trifluoromethanesulfonic acid or Lewis acids such as tin tetrachloride, arsenic pentafluoride, phosphorus pentafluoride and boron trifluoride and also complexes and salt-like compounds derived therefrom, e.g. boron trifluoride etherates and triphenyl-methylene hexafluoroposphate. The initiators (catalysts) are used in amounts of from about 0.01 to 1000 ppm, preferably from 0.01 to 500 ppm and in particular from 0.01 to 200 ppm. In general, it is advisable to use the initiator in diluted form, preferably in concentrations of from 0.005 to 5% by weight. Solvents which can be used for this purpose are inert compounds such as aliphatic, cycloaliphatic hydrocarbons, e.g. cyclohexane, halogenated aliphatic hydrocarbons, glycol ethers, etc. Particular preference is given to triglyme (triethylene glycol dimethyl ether) as solvent and also 1,4-dioxane.

In addition to the initiators, it is possible to make concomitant use of cocatalysts. These are alcohols of any type, for example aliphatic alcohols having from 2 to 20 carbon atoms, e.g. t-amyl alcohol, methanol, ethanol, propanol, butanol, pentanol, hexanol; aromatic alcohols having from 2 to 30 carbon atoms, e.g. hydroquinone; halogenated alcohols having from 2 to 20 carbon atoms, e.g. hexafluoroisopropanol; very particular preference is given to glycols of any type, in particular diethylene glycol and triethylene glycol; and aliphatic dihydroxy compounds, in particular diols having from 2 to 6 carbon atoms, e.g. 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol.

Monomers, initiators, cocatalysts and, if appropriate, regulators can be premixed in any way or introduced separately from one another into the polymerization reactor.

Furthermore, the components can comprise sterically hindered phenols to achieve stabilization, as described in EP-A 129369 or EP-A 128739.

The polymerization mixture is preferably deactivated immediately subsequent to the polymerization, preferably without a phase change occurring. The deactivation of the initiator residues (catalyst residues) is generally achieved by addition of deactivators (terminating agents) to the polymerization melt. Suitable deactivators are, for example, ammonia and primary, secondary or tertiary, aliphatic and aromatic amines, e.g. trialkylamines such as triethylamine or triacetonediamine. Further suitable deactivators are salts having a basic reaction, e.g. sodium carbonate and borax, also the carbonates and hydroxides of the alkali metals and alkaline earth metals, in addition alkoxides such as sodium ethoxide. The deactivators are usually added to the polymers in amounts of preferably from 0.01 ppmw (parts per million by weight) to 2% by weight. Furthermore, preference is given to alkali metal alkyls and alkaline earth metal alkyls having from 2 to 30 carbon atoms in the alkyl radical as deactivators. Particularly preferred metals are Li, Mg and Na, with n-butyllithium being particularly preferred.

POMs prepared from trioxane are generally obtained by polymerization in bulk, for which purpose it is possible to use any reactors having a high mixing action. The reaction can be carried out homogeneously, e.g. in a melt, or heterogeneously, e.g. as a polymerization to form a solid or pelletized solid. Suitable reactors are, for example, pan reactors, plowshare mixers, tube reactors, List reactors, kneaders (e.g. Buss kneaders), extruders having, for example, one or two screws and stirred reactors, with the reactors being able to have static or dynamic mixers.

In the case of a bulk polymerization, e.g. in an extruder, the molten polymer forms a melt seal, as a result of which volatile constituents remain in the extruder. The above monomers are introduced into the polymer melt present in the extruder, either together with or separately from the initiators (catalysts), at a preferred temperature of the reaction mixture of from 62 to 114° C. The monomers (trioxane) are preferably also introduced in the molten state, e.g. at from 60 to 120° C. Owing to the exothermic nature of the process, the polymer only has to be melted in the extruder at the beginning of the process; subsequently, the quantity of heat liberated is sufficient to melt the POM polymer formed or keep it molten.

The melt polymerization is generally carried out at from 1.5 to 500 bar and from 130 to 300° C., and the residence time of the polymerization mixture in the reactor is usually from 0.1 to 20 minutes, preferably from 0.4 to 5 minutes. The polymerization is preferably carried out to a conversion above 30%, e.g. from 60 to 90%.

In any case, a crude POM which, as mentioned, displays considerable advantages, for example it comprises up to 40% of unreacted residual monomers, in particular trioxane and formaldehyde, is obtained. Formaldehyde can be present in the crude POM even when only trioxane has been used as monomer, since it can be formed as degradation product of trioxane. In addition, other oligomers of formaldehyde, e.g. the tetramer tetroxane, can also be present.

According to the process of the invention, trioxane is used as monomer for preparing the POM, which is why the residual monomers taken off also comprise trioxane, usually together with from 0.5 to 10% by weight of tetroxane and from 0.1 to 75% by weight of formaldehyde.

To carry out the process, trioxane is firstly prepared in a monomer plant in a purity which meets the specifications required for use as monomer in the polymer plant: this can be pure trioxane, i.e. a stream having a minimum content of 97.5% by weight, preferably 99% by weight or 99.5% by weight, of trioxane or high-purity trioxane, i.e. a stream having a minimum content of 99.9% by weight of trioxane.

According to the invention, it is possible to use any known process for preparing polymerizable trioxane, which comprises the following process steps:
acid-catalyzed reaction of a concentrated aqueous formaldehyde solution in a reactor to give a trioxane/formaldehyde/water mixture,
distillation or crystallization of the trioxane/formaldehyde/water mixture to give crude trioxane and
work-up of the crude trioxane in one or more further process steps to give polymerizable trioxane and pure water. In particular, this can be a process as is described, for example, in DE 102004051118.7.

The distillation of the trioxane/formaldehyde/water mixture from the reactor is carried out in a column which can, in a preferred process variant, be connected to the reactor to form one unit so that the vapor rising from the reactor directly enters the column and the liquid flowing down from the column directly enters the reactor.

The crude trioxane stream from this first column is passed to a second column for overhead separation of low boilers.

The bottom stream from the low boiler separation column is worked up in a pure trioxane column from which a trioxane stream having a purity corresponding to the above-defined pure trioxane or high-purity trioxane is obtained as side offtake stream or bottom stream and is fed to the polymerization plant.

The overhead stream from the pure trioxane column is passed to a further column in which water is taken off at the bottom and an overhead stream is taken off and recycled to the first distillation column.

The polymerizable trioxane, i.e. the stream comprising pure or high-purity trioxane corresponding to the above definition, is fed to a polymerization plant which is operated in a known manner, for example using the process described in DE 102005002413.0.

Here, the POM which still comprises residual monomers is firstly prepared in a polymerization reactor, preferably by bulk polymerization.

This POM is subsequently degassed in one or more stages in known degassing apparatuses, for example in degassing pots (flash pots), vented extruders having one or more screws, thin film evaporators, spray dryers or other customary degassing apparatuses. Particular preference is given to degassing pots (flash pots).

The degassing of the crude polyoxymethylene is preferably carried out by degassing to below 6 bar absolute in a first flash pot to give a gaseous stream and a liquid stream which is fed to a second flash pot which is operated at below 2 bar absolute to give a vapor stream which is recycled to the monomer plant.

For example, the pressure in the first stage of a two-stage degassing process can preferably be from 2 to 18 bar, in particular from 2 to 15 bar and particularly preferably from 2 to 10 bar, and that in the second stage can preferably be from 1.05 to 4 bar, in particular from 1.05 to 3.05 bar and particularly preferably from 1.05 to 3 bar.

The residual monomers liberated during degassing are, if appropriate, taken off as one or more vapor streams and passed to a condenser. The condenser is preferably operated so that the condensate stream obtained has a higher proportion of trioxane than the uncondensed vapor stream.

This gives a condensate which is recycled to the polymerization reactor and also a gaseous, formaldehyde-comprising stream. The partially degassed polyoxymethylene homopolymer or copolymer is subsequently fed to an extruder or kneader and is there provided with customary additives and processing aids in the amounts customary for these materials. Such additives are, for example, lubricants or mold release agents, colorants such as pigments or dyes, flame retardants, antioxidants, stabilizers against the action of light, formaldehyde scavengers, polyamides, nucleating agents, fibrous and pulverulent fillers or reinforcing materials or antistatics and also other additives or mixtures thereof.

The desired product POM is obtained as a melt from the extruder or kneader.

A further formaldehyde-comprising secondary stream is taken off as extruder or kneader offgas at the extruder or kneader dome.

The inventors have found that it is possible for all formaldehyde-comprising secondary streams obtained in the polymer plant to be recirculated directly, i.e. in the form in which they are obtained in the polymer plant, without chemical alteration and without addition of auxiliaries, to in each case a suitable point in the monomer plant.

Here, both the material composition and the energy content of these streams are utilized in the monomer plant and thus in the overall process for preparing POM.

The gaseous, formaldehyde-comprising secondary streams which are obtained in the single-stage or multistage depressurization of the polymer melt from the polymerization reactor and remain in the gaseous state after the condensation are, according to the invention, recycled to the polymer plant.

The gaseous formaldehyde-comprising stream from the polymer plant is preferably recycled to the first column of the monomer plant.

Here, the operating conditions in the condenser are preferably set so that the proportion of trioxane in the gaseous formaldehyde-comprising stream from the polymer plant which is recycled to the monomer plant is less than 80% by weight, preferably less than 60% by weight, particularly preferably less than 40% by weight.

This stream generally has a formaldehyde content of preferably at least 25% by weight, more preferably at least 50% by weight.

One or more further formaldehyde-comprising secondary streams, viz. the extruder or kneader offgas, are obtained at the extruder dome or kneader dome and are, according to the invention, likewise recycled directly, i.e. without chemical or physical alteration, to the monomer plant.

A subatmospheric pressure is generally generated at the extruder dome or kneader dome; frequently in the range below 800 mbar in a first stage and a lower pressure, frequently in the range below 500 mbar, in a second stage.

The extruder or kneader offgas is, according to the invention, taken up in the liquid ring pump which is in any case present in the monomer process in order to compress a water-rich liquid stream, in particular the overhead stream from the evaporation of the formaldehyde feed stream from an initial concentration of about 10-60% by weight, in particular about 15-45% by weight, to the pressure of the fourth column for the removal of water which precedes the reactor for the preparation of trioxane.

In particular, the extruder offgas taken up in the liquid ring pump is compressed to a pressure of from 2 to 7 bar absolute, preferably to about 5 bar absolute.

The invention is illustrated below with the aid of a FIGURE and an example.

The single FIGURE schematically shows a preferred plant for carrying out the process of the invention.

An aqueous formaldehyde solution FA is concentrated in an evaporator V to give a high-concentration aqueous formaldehyde solution having a formaldehyde content of at least 60% by weight, stream 1. Stream 1 is reacted in a reactor R to form trioxane which is obtained as a trioxane/formaldehyde/water mixture 2, this is passed to a first distillation column KII and an overhead stream 3 comprising crude trioxane is separated off there. The bottom stream 4 from the first distillation column KII is recycled to a point upstream of the reactor R and a substream thereof, stream 5 is discharged.

The crude trioxane overhead stream 3 from the first column KII is passed to a second column KIII in which low boilers, stream 6, comprising, in particular, methylal, methanol and methyl formate are separated off at the top. The bottom stream 7 from the second distillation column KIII is passed to a third column, the pure trioxane column KIV, from which a trioxane stream 8 which comprises polymerizable trioxane and can thus be fed to the polymer plant is taken off as side offtake stream or at the bottom. The overhead stream 9 from the third distillation column KIV is passed to a further fourth column KV in which water is taken off as bottom stream 10 and an overhead stream 11 is taken off and recycled to the first distillation column KII.

The stream 8 comprising polymerizable trioxane from the third distillation column KIV is fed to the polymerization reactor P of the polymerization plant, in which crude POM, stream 12, is obtained by bulk polymerization under superatmospheric pressure. Stream 12 further comprises residual monomers which, in the preferred variant shown in the FIGURE, are removed by degassing in two stages. In a first degassing stage F1, a vapor stream 13 is obtained and is recycled to the condenser K where it is partly condensed to give a condensate stream 15 which is recycled to the polymerization reactor P and a gaseous, formaldehyde-comprising stream 16 which is recirculated to the first column KII in the monomer plant.

In a second degassing stage F2, a further vapor stream 14 is, in the preferred variant shown in the FIGURE, taken off at a pressure lower than that in the first degassing stage and is likewise recirculated directly to the first column KII of the monomer plant. The partially degassed POM, stream 17, is fed to an extruder E and there mixed with customary additives and processing aids to give a polymer melt 19 and an extruder offgas 18 which is passed to a liquid ring pump F which is operated by means of the overhead stream from the evaporator V for formaldehyde FA. The extruder offgas 18 is taken up in the liquid of the liquid ring pump F, compressed to the pressure of the fourth distillation column KV and fed to the latter as stream 19.

### EXAMPLE

The crude POM stream 12 from the polymerization reactor P is degassed in two stages to give the vapor streams 13 and 14.

The vapor stream 13 is partly condensed in the condenser K to give the condensate stream 15 and the vapor stream 16.

The vapor streams 14 and 16 are recycled to the monomer plant for preparing trioxane, as is the extruder offgas 18.

According to the mode of operation shown by way of example, a proportion of about 11% of the feed stream 8 to the polymer plant is recycled as vapor stream 16 to the monomer plant, a further proportion of about 5% of the same feed stream is recycled as vapor stream 14 and an additional proportion of about 6% of the same feed stream is recycled as extruder offgas 18. Thus, a total of about 22% of the trioxane feed stream to the polymer plant is recycled directly without further chemical or physical treatment to the monomer plant.

### COMPARATIVE EXAMPLE

For comparison, the gaseous formaldehyde-comprising streams 14 and 16 and the extruder off gas 18 were, corresponding to the conventional process, scrubbed out by means of a 5-fold excess of water and subsequently recycled to the trioxane plant. The extruder off gas 18 is in this case scrubbed out into water by means of a liquid ring pump.

Thus, a total of about 22% by weight of the trioxane feed stream to the polymer plant is, as offgas comprising mainly trioxane and formaldehyde, scrubbed out into water. This gives a stream which is 32% (by mass) larger than the trioxane feed stream to the monomer plant. This stream is fed to the monomer plant.

The following advantages are achieved by the inventive process presented in the example compared to the conventional mode of operation described in the comparative example:

Since the formaldehyde-comprising secondary streams obtained can be recycled directly and do not require any further treatment, for example an offgas scrub, this mode of operation is associated with a cost advantage of at least 3-8% compared to a conventional plant.

Since recirculation occurs without admixture of water, the energy advantage compared to a conventional process is at least 30%.

Furthermore, the operation of the plant is trouble-free; in particular, the gaseous formaldehyde-comprising recycle streams do not form any deposits which block the return lines since they are recirculated without addition of water.

1-7. (canceled)

8. A process for preparing polyoxymethylene homopolymers or copolymers by homopolymerization or copolymerization of trioxane or additionally of suitable comonomers, wherein
trioxane is first prepared in a monomer plant by
acid-catalyzed reaction of a high-concentration aqueous formaldehyde solution in a reactor to give a trioxane/formaldehyde/water mixture,
distillation or crystallization of the trioxane/formaldehyde/water mixture to give crude trioxane as overhead stream and
work-up of the crude trioxane in one or more further process steps to give trioxane and water,
the trioxane obtained in the monomer plant or additionally suitable comonomers are fed to a polymerization plant wherein
the crude polyoxymethylene homopolymer or copolymer which still comprises residual monomers is prepared in a polymerization reactor and is
degassed in one or more stages to give one or more vapor streams which are, if appropriate, fed to a condenser to give a condensate which is recycled to the polymerization reactor and one or more gaseous, formaldehyde-comprising streams and also a partially degassed polyoxymethylene homopolymer or copolymer which
is fed to an extruder or kneader and is mixed with customary additives and processing aids in this
to give a polymer melt and
extraction of a formaldehyde-comprising extruder or kneader offgas from the extruder or kneader,
wherein the formaldehyde-comprising secondary streams from the polymer plant are recycled directly without addition of water as auxiliary to the monomer plant.

9. The process according to claim 8, wherein the distillation of the trioxane/formaldehyde/water mixture from the reactor is carried out in a first column and the crude trioxane overhead stream from the first column is passed to a second column in which a stream comprising low boilers is separated off at the top and a bottom stream is taken off and passed to a third pure trioxane column from which a trioxane stream is obtained as side offtake stream or bottom stream and is fed to the polymer plant and an overhead stream is taken off and passed to a fourth column in which water is taken off as bottom stream and an overhead stream is taken off and recycled to the first column.

10. The process according to claim 9, wherein the gaseous formaldehyde-comprising stream from the polymer plant is recycled to the first column.

11. The process according to claim 10, wherein the gaseous formaldehyde-comprising stream comprises less than 80% by weight of trioxane or less than 60% by weight of trioxane.

12. The process according to claim 9, wherein the formaldehyde-comprising extruder offgas is taken up in a liquid ring pump which is operated using a liquid from the monomer plant within the process to give a stream which is compressed in the liquid ring pump to the pressure of the fourth column and recycled to the fourth column.

13. The process according to claim 12, wherein the stream is compressed in the liquid ring pump to a pressure of from 4 to 6 bar absolute.

14. The process according to claim 9, wherein the degassing of the crude polyoxymethylene is carried out to less than 6 bar absolute in a first flash pot to give a gaseous stream and a liquid stream which is fed to a second flash pot which is operated at less than 1 bar absolute to give a vapor stream which is recycled to the monomer plant.

15. The process according to claim 11, wherein the gaseous formaldehyde-comprising stream comprises less than 40% by weight of trioxane.

16. The process according to claim 13, wherein the stream is compressed in the liquid ring pump to a pressure of 5.5 bar absolute.

17. The process according to claim 10, wherein the formaldehyde-comprising extruder offgas is taken up in a liquid ring pump which is operated using a liquid from the monomer plant within the process to give a stream which is compressed in the liquid ring pump to the pressure of the fourth column and recycled to the fourth column.

18. The process according to claim 11, wherein the formaldehyde-comprising extruder offgas is taken up in a liquid ring pump which is operated using a liquid from the monomer plant within the process to give a stream which is compressed in the liquid ring pump to the pressure of the fourth column and recycled to the fourth column.

19. The process according to claim 10, wherein the degassing of the crude polyoxymethylene is carried out to less than 6 bar absolute in a first flash pot to give a gaseous stream and a liquid stream which is fed to a second flash pot which is operated at less than 1 bar absolute to give a vapor stream which is recycled to the monomer plant.

20. The process according to claim 11, wherein the degassing of the crude polyoxymethylene is carried out to less than 6 bar absolute in a first flash pot to give a gaseous stream and a liquid stream which is fed to a second flash pot which is operated at less than 1 bar absolute to give a vapor stream which is recycled to the monomer plant.

21. The process according to claim 12, wherein the degassing of the crude polyoxymethylene is carried out to less than 6 bar absolute in a first flash pot to give a gaseous stream and a liquid stream which is fed to a second flash pot which is operated at less than 1 bar absolute to give a vapor stream which is recycled to the monomer plant.

22. The process according to claim 13, wherein the degassing of the crude polyoxymethylene is carried out to less than 6 bar absolute in a first flash pot to give a gaseous stream and a liquid stream which is fed to a second flash pot which is operated at less than 1 bar absolute to give a vapor stream which is recycled to the monomer plant.
